(19) United States
(12) Patent Application Publication
(10) Pub. No.: US 2015/0137053 A1
(43) Pub. Date: May 21, 2015

(54) DEVICE FOR IMPROVING THE ATTACHMENT OF WIRES, IN PARTICULAR ELECTRIC WIRES, TO FACILITATE PULLING OF SAME IN CONDUITS

(71) Applicant: ROBOTIC CONSULTING S.à r.l., Estavayer-le-Lac (CH)

(72) Inventor: Gianfranco Passoni, Chatillon (CH)

(21) Appl. No.: 14/388,841

(22) PCT Filed: May 28, 2013
(86) PCT No.: PCT/CH2013/000091

§ 371 Date: Jan. 18, 2015

(30) Foreign Application Priority Data
Apr. 11, 2012 (CH) 501/12

(51) Int. Cl. H02G 1/08

(52) U.S. Cl. CPC H02G 1/081
USPC 254/134.3 R

(57) ABSTRACT

This device comprises an end piece 4. Said end piece 4 has a cylindrical body having a longitudinal axis, comprising a front portion 8 and a rear portion 6. Front portion 8 is a convex envelope of revolution about said axis, and rear portion 6 has a recess in the shape of a cone frustum 9 of which the large base merges with the base of rear portion 6. Said cone frustum comprises, on the inner surface of same, a conical thread 10 and said front portion has an opening 7 in the distal portion of same. Moreover, the device comprises, in one embodiment, a wire 2 in the form of a loop. The device comprises end pieces of different diameters in order to be disposed on different numbers of wires and different diameters.

### TECHNICAL FIELD

An object of the present invention relates to a device to improve the attachment of wires, particularly electrical, to facilitate their pulling in conduits or tubes. This device is, in particular, designed to be used with a wire-pull device for electrical wiring of the kind described in Swiss patent application CH 700762.

In the patent application CH 700762 it is described how electrical wires are inserted into conduits or tubes. The electricans push a probe into the inlet of a conduit section designed to receive a batch of electrical wires, up to the outlet of the section. The end of the aforementioned probe has means for attaching the electrical wires. These means are designated stud in the patent application CH 700792 and include the reference symbol 21 in the the aforementioned patent application. The problem that the invention aims to resolve is, in particular, the attachment of the electrical wires to the aforementioned stud.

### PRIOR ART

The attachment means are often simple rings. The attachment of the wires is then made by stripping a part of the end of the wires and making a hook that is passed through the loop of the ring. This way of doing it required a relatively long time, because it additionally requires attachment of the wires with tape to prevent the roosters from opening and the edges of the insulation from attaching in the conduits. Moreover this approach causes losses of copper wires, because cutting of the ends of bare wires is required. The document WO 2004/002863 discloses a device for preventing the hooks from attaching in the tube. It is constituted by a cone positioned on the hooks, the cone being open at the top, the wire intended to pull the cable passing through the opening. This device requires a relatively long time during wire use. The document FR 2832259 discloses an attachment device for electrical conductors. This device is constituted by a body made of flexible material, of elongate shape, equipped with a rounded endpiece provided with an orifice for passage of the wire puller and attachment means for the conductors. The attachment means is constituted by orifices through which unstripped wires are passed. This device avoids the loss of time due to the wire stripping, but it will not avoid the loss of copper wires at the time of unhooking. Although it saves time because there is no need to strip the wires, this device has no means facilitating the passage of wires in the conduit. In the document U.S. Pat. No. 4,171,123 a device is described of the same type as defined in FR 2832259, but with an improvement designed to reduce the risk of attachment in the conduit or tube.

### DISCLOSURE OF INVENTION

An object of the invention is to furnish a device to improve the attachment of wires, particularly electrical, to facilitate their pulling in conduits or tubes, not having the disadvantages of the devices described above. That is to say a device that does not require having to strip the electrical wires that one wishes to insert in a conduit, having to make hooks, having to cut the wires after their passage through a tube, and comprising means for facilitating the passage through the conduits.

These objects are achieved with the device for improving the attachment of wires, particularly electrical, for facilitating their pulling in conduits or tubes, according to the invention defined in claim 1.

The characteristics and advantages of the invention will be better understood upon reading the description of implementation forms of the device for improving the attachment of wires, particularly electrical, for facilitating their pulling in conduits or tubes. With reference to the accompanying drawings, given as a guide and non limiting, in which:

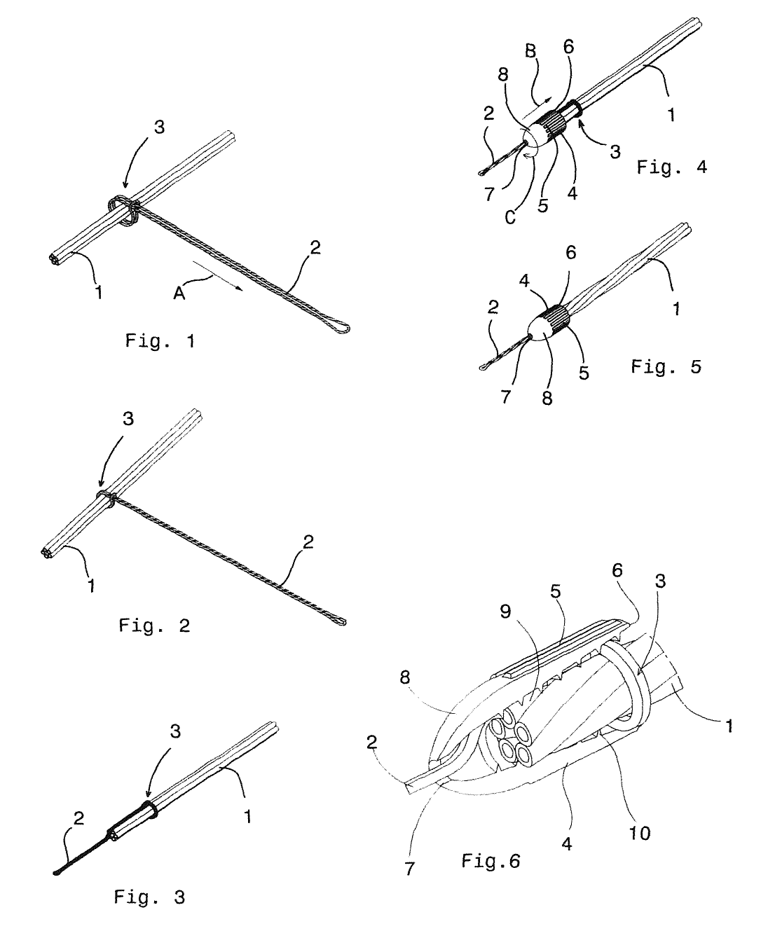

FIGS. 1, 2 and 3 show how a set of five wires is seized and attached,

FIG. 4 shows the manner of positioning the endpiece on the end of a set of wires,

FIG. 5 shows the endpiece positioned on the end of the wires,

FIG. 6 shows in perspective the interior of an endpiece according to an implemention form of the invention.

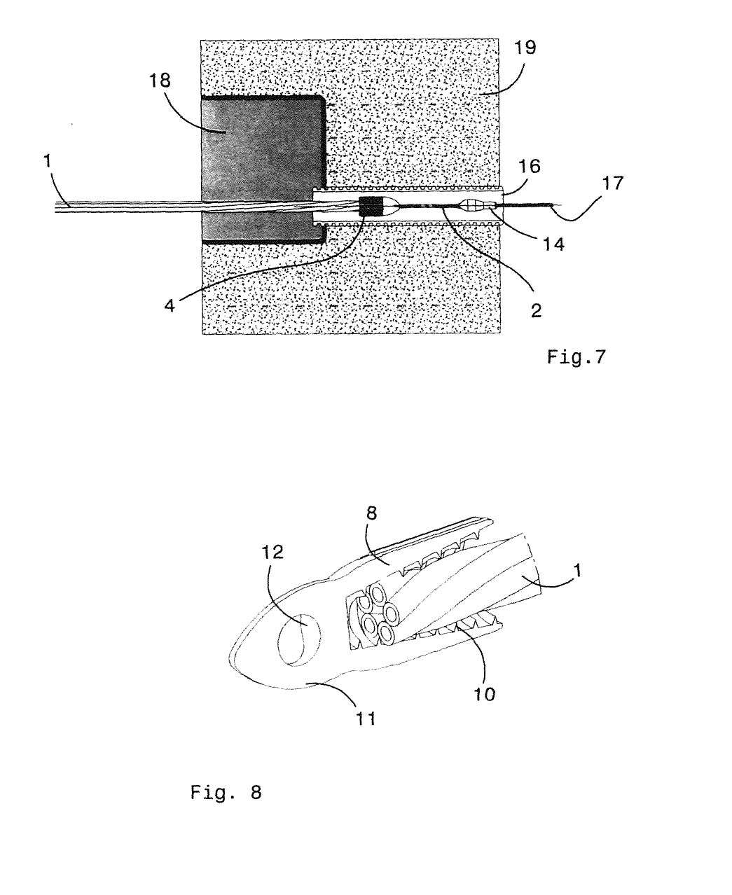

FIG. 7 shows the device inserted in a conduit,

FIGS. 8, 9 and 10 show varients of means for attaching the endpiece according to the invention.

It will be noted that in all the figures the same reference symbols have been used to denote the same features.

Referring to FIGS. 1 to 3, there is shown how a set of five electrical wires 1, intended to be inserted into a conduit positioned in a building wall, is attached with the wire of 2 of a device according to the invention. The wire 2 will be a flexible and resilient wire or made of metal or a synthetic material known to the person of skill in the art. To do this a loop 3 will be made around of the wires 1 and the wire 2 will be pulled in the direction of arrow A so as to clamp the wire 2 around the set of wire 1. Then the wire 2 will be displaced as to be positioned in the axis of the electrical wires 1.

Referring to FIGS. 4 and 5, there is shown how an endpiece 4 of a device according to the invention is positioned on the set of electrical wires 1. The wire 2 is inserted into the endpiece 4 via its rear part 6 and brought out through the orifice 7 provided at the distal part of its front part 8. Then the endpiece will be pushed onto the unstripped wires of the set 1 in the direction of the arrow B. At the same time the wire 2 will be pulled so as to place the knot 3 into the cylindrical part of the endpiece 4 and the latter will be screwed as indicated by the arrow C on the set of wires 1. A knurling 5 is provided on the cylindrical part of the endpiece 4 in order the facilite the screwing. FIG. 5 shows the endpiece positioned on the set of wires 1 ready to be attached to a pull-wire, for example as defined in patent application CH 700762.

In FIG. 7 there has been shown a device according to the invention ready to enable the insertion of the set of wires 1 into a conduit 16 positioned in a box 18, itself positioned in a wall 19. The wires 1 are pulled by a cable 17, forming part of a cable traction device defined in patent application CH 700762 attached to the wire 2 by a stud 14.

Referring to FIG. 6, there has been shown in perspective the interior of the endpiece 4. The tapered cavity 9 is seen, starting at the rear part 6 of the endpiece 4, wherein the wires 1 are inserted and screwed on the tapered threads, of which is seen part of the threading 10. The front part 8 of the endpiece is constituted by an envelope of revolution, for example: a half-ellipsoid, a hemisphere or a paraboloid of revolution, having at its top or distal part an orifice 7 to allow the attachment wire 2 to exit. As can be noticed the wires 1 are firmly held in the endpiece 4 and the higher the traction force the firmer the holding.

In another variant shown in FIG. 8, the endpiece 4 is seen having on its front part 8 a plate 1 comprising an orifice 12 designed to be attached to a pull wire. This variant enables screwing the wires in the tapered thread provided in the interior of the body of the endpiece.

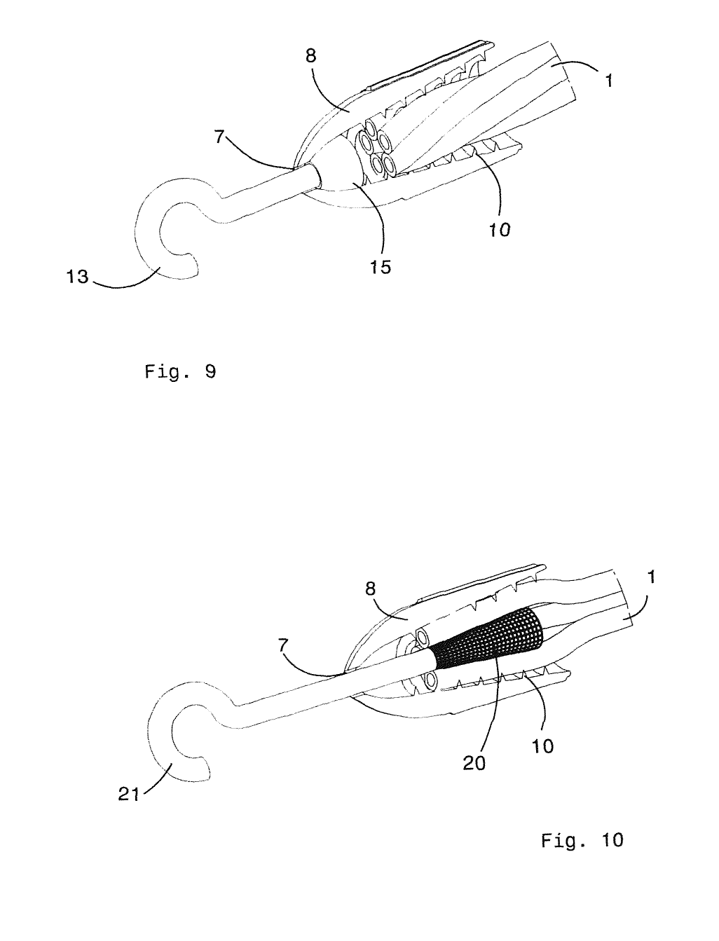

In FIG. 9 there is shown an implementation form of the endpiece comprising a hook 13 attached to the distal part of the front part 8 of the endpiece. This hook is screwed on piece 15 positioned in the interior of the front part 8. This variant also enables screwing the wires in the tapered therads provided in the interior of the body of the endpiece.

In FIG. 10 another implementation form has been shown, comprising in the interior of the tapered part 20 on which is screwed a hook 21. The tapered part 20 will pinching of the wires 1 against the tapered thread 10, which will improve the holding of wires 1.

Tests showed that the tapered threading provides holding of wires in the endpiece sufficient to enable a traction, without which they detach.

As can be observed, this device is easy to use is fast. Indeed, an endpiece is attached directly to the wires to be pulled without needing to strip them, the wires are pulled and the endpiece is recovered when the wires emerge at the outlet of the conduit. Advantageously, the device is provided with endpieces of different diameters depending on the desired number of wires to be pulled.

Different variants and modifications can be made to the device in order to faciliate the pulling of wires, paricularly electrical, in conduits or tubes without departing from the scope of the invention. The exterior part of the endpiece can be tapered.

1. Device for improving the attachment of wires, particularly electrical, for facilitating their pulling in conduits or tubes, comprising an endpiece, characterized in that the endpiece has a body of revolution having a longitudinal axis, comprising a front part and a rear part, the front part being a convex envelope of revolution about the aforementioned axis, the rear part having a hollow in the shape of a cone frustrum whose large base coincides with the base of the rear part, the aforementioned cone frustrum comprising on its interior surface a tapered thread and the aforementioned front part having means for enabling an attachment.

2. Device according to claim 1, characterized in that the means for enabling an attachment are constituted by a wire loop, synthetic for example, bound on the electrical wires and exiting through an orifice provided at the distal part of the front part.

3. Device according to claim 1, characterized in that the means for enabling an attachment are constituted by a plate comprising an orifice, positioned in front of the front part of the endpiece.

4. Device according to claim 1, characterized in that the means for enabling an attachment are constituted by a hook exiting through an orifice provided at the distal part of the front part, the aforementioned hook being screwed on a part positioned in the interior of the front part of the endpiece.

5. Device according to claim 1, characterized in that the endpiece comprises a knurling on its exterior surface.
